(19) United States
(12) Patent Application Publication
(10) Pub. No.: US 2024/0112465 A1
(43) Pub. Date: Apr. 4, 2024

(54) Image Processing System, Method and Device, and Computer-Readable Medium

(71) Applicant: Siemens Aktiengesellschaft, München (DE)

(72) Inventors: Yue Yu, Chuzhou, Jiangsu Province (CN); Chang Wei Loh, 223200 Suzhou, Jiangsu Province (CN); Wei Yu Chen, Suzhou (CN); Tian Hua Pan, Beijing (CN); Sheng Bo Hu, Suzhou (CN)

(73) Assignee: Siemens Aktiengesellschaft, München (DE)

(21) Appl. No.: 18/261,890

(22) PCT Filed: Jan. 18, 2022
(86) PCT No.: PCT/US2022/012734

§ 371 Date: Jul. 18, 2023

(30) Foreign Application Priority Data
Jan. 20, 2021 (CN) 202110076088.5

(51) Int. Cl. G06V 20/40; G06V 10/25; G06V 10/762; G06V 20/52; H04L 65/60

(52) U.S. Cl. CPC G06V 20/41; G06V 10/25; G06V 10/762; G06V 20/46; G06V 20/49; G06V 20/52; H04L 65/60; G06V 2201/07

(57) ABSTRACT

Various embodiments of the teachings herein include an image processing system comprising: a video stream processing device configured to receive a video stream, segment the video stream into multiple frames of pictures arranged in chronological order, and distribute the multiple frames of pictures to edge computing devices in a connected edge computing device group; and a picture collecting device configured to receive pictures from the edge computing device group. The individual edge computing devices in the edge computing device group are each configured to subject the received pictures to target identification, and send the pictures marked with a region in which an identified target is located. The picture collecting device is further configured to restore in chronological order as a video stream the received pictures marked with target identification results.

### CROSS-REFERENCE TO RELATED APPLICATIONS

This application is a U.S. National Stage Application of International Application No. PCT/US2022/012734 filed Jan. 18, 2022, which designates the United States of America, and claims priority to CN Application No. 202110076088.5 filed Jan. 20, 2021, the contents of which are hereby incorporated by reference in their entirety.

### TECHNICAL FIELD

The teachings of the present disclosure relate to computer vision. Various embodiments of the teachings herein may include image processing systems, methods, and/or devices.

### BACKGROUND

In the field of computer vision, target identification processing speed and accuracy are two important indices. In some application scenarios, the processing speed when target identification is performed is more important. However, if a target identification task is completed at an edge side, the processing speed requirements are often unattainable due to the low computing power of most edge computing devices at present. For example: many edge devices are only able to achieve a processing speed of 3-4 frames per second when performing video monitoring, but application scenarios such as video monitoring generally require a processing speed of at least 24 frames per second. In such application scenarios, it becomes especially important to increase the processing speed of edge computing devices.

At present, a common method is to use a server or workstation with a high-performance image processor (graphics processing unit, GPU), or use a specially customized edge computing device, but both types of device have a high cost. Another method is to transmit a video stream to the cloud for further analysis, but this will result in a long network delay and as well as a safety risk.

### SUMMARY

Some embodiment of the teachings herein include an image processing system (100), comprising: a video stream processing device (10), configured to receive a video stream, segment the video stream into multiple frames of pictures arranged in chronological order, and distribute the multiple frames of pictures to edge computing devices (201) in a connected edge computing device group (20); the edge computing devices (201) in the edge computing device group (20), configured to subject the received pictures to target identification, and send, to a connected picture collecting device (30), the pictures marked with a region in which an identified target is located; and the picture collecting device (30), configured to restore in chronological order as a video stream the received pictures marked with target identification results.

In some embodiments, the video stream processing device (10) is further configured to: monitor a state of each edge computing device (201) in the edge computing device group (20) and a state of each connected edge computing device (202) outside the edge computing device group (20); when the state of a first edge computing device (201) in the edge computing device group (20) changes to “unavailable”, remove the first edge computing device (201) from the edge computing device group (20); and when the state of a connected second edge computing device (202) outside the edge computing device group (20) changes to “can be added to the edge computing device group (20)”, add the second edge computing device (202) to the edge computing device group (20).

In some embodiments, the system (100) is used for monitoring a region of interest, the edge computing devices (201) in the edge computing device group (20) being further configured to: mark the region of interest in the received pictures; the picture collecting device (30) being further configured to: judge whether there is an overlap between the region in which the identified target is located and the region of interest marked in each frame of picture received; if there is an overlap, then judge the degree to which the proportion of the area of the region of interest taken up by a region of overlap changes within a preset time period; and if the degree of change exceeds a preset change degree threshold, then output an alert.

In some embodiments, the picture collecting device (30) is further configured to: compare information of pre-stored targets and the target identified in the received pictures, and judge whether the identified target conforms to information of one pre-stored target; and if the identified target conforms to information of one pre-stored target, then mark, in the outputted alert, target information of the pre-stored identified target.

In some embodiments, the picture collecting device (30) is further configured to: if the identified target does not conform to information of any pre-stored target, then extract a feature of a key part of the target identified in each frame of picture in the video stream in the preset time period, the key part being used to distinguish between different targets; cluster the frames of pictures according to the extracted feature; acquire a feature located at the cluster center point; obtain the key part of the target in the picture that is most similar to the feature located at the cluster center point; and mark the key part so obtained in the outputted alert.

As another example, some embodiments include an image processing method (400), comprising: receiving (S401) a video stream; segmenting (S402) the video stream into multiple frames of pictures arranged in chronological order; distributing (S403) the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream; monitoring (S404) a state of each edge computing device in the edge computing device group and a state of each connected edge computing device outside the edge computing device group; when the state of a first edge computing device in the edge computing device group changes to “unavailable”, removing (S405) the first edge computing device from the edge computing device group; and when the state of a connected second edge computing device outside the edge computing device group changes to “can be added to the edge computing device group”, adding (S406) the second edge computing device to the edge computing device group.

As another example, some embodiments include an image processing method (500), for monitoring a region of interest, comprising: receiving (S501) multiple frames of pictures arranged in chronological order, wherein each frame of picture is marked with a region in which a target identified by target identification is located and the region of interest; judging (S502) whether there is an overlap between the region in which the identified target is located and the region of interest marked in each frame of picture received; if there is an overlap, then judging (S503) the degree to which the proportion of the area of the region of interest taken up by a region of overlap changes within a preset time period; and, if the degree of change exceeds a preset change degree threshold, then outputting (S504) an alert.

In some embodiments, the method (500) further comprises: comparing (S505) information of pre-stored targets and the target identified in the received pictures, and judging whether the identified target conforms to information of one pre-stored target; if the identified target conforms to information of one pre-stored target, then marking (S506), in the outputted alert, target information of the pre-stored identified target.

In some embodiments, the method (500) further comprises: if the identified target does not conform to information of any pre-stored target, then extracting (S507) a feature of a key part of the target identified in each frame of picture in the video stream in the preset time period, the key part being used to distinguish between different targets; clustering (S508) the frames of pictures according to the extracted feature; acquiring (S509) a feature located at the cluster center point; obtaining (S510) the key part of the target in the picture that is most similar to the feature located at the cluster center point; and marking (S511) the key part so obtained in the outputted alert.

As another example, some embodiments include a video stream processing device (10), comprising: a receiving module (111), configured to receive a video stream; a segmenting module (112), configured to segment the video stream into multiple frames of pictures arranged in chronological order; a distributing module (113), configured to distribute the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream; a monitoring module (114), configured to: monitor a state of each edge computing device in the edge computing device group and a state of each connected edge computing device outside the edge computing device group; when the state of a first edge computing device in the edge computing device group changes to “unavailable”, remove the first edge computing device from the edge computing device group; and when the state of a connected second edge computing device outside the edge computing device group changes to “can be added to the edge computing device group”, add the second edge computing device to the edge computing device group.

As another example, some embodiments include a picture collecting device (30), for monitoring a region of interest, comprising: a receiving module (211), configured to receive multiple frames of pictures arranged in chronological order, wherein each frame of picture is marked with a region in which a target identified by target identification is located and the region of interest; an alerting module (212), configured to: judge whether there is an overlap between the region in which the identified target is located and the region of interest marked in each frame of picture received; if there is an overlap, then judge the degree to which the proportion of the area of the region of interest taken up by a region of overlap changes within a preset time period; and if the degree of change exceeds a preset change degree threshold, then output an alert.

In some embodiments, the alerting module (212) is further configured to: compare information of pre-stored targets and the target identified in the pictures received by the receiving module (211), and judge whether the identified target conforms to information of one pre-stored target; and if the identified target conforms to information of one pre-stored target, then mark, in the outputted alert, target information of the pre-stored identified target.

In some embodiments, the alerting module (212) is further configured to: if the identified target does not conform to information of any pre-stored target, then extract a feature of a key part of the target identified in each frame of picture in the video stream in the preset time period, the key part being used to distinguish between different targets; cluster the frames of pictures according to the extracted feature; acquire a feature located at the cluster center point; obtain the key part of the target in the picture that is most similar to the feature located at the cluster center point; and mark the key part so obtained in the outputted alert.

As another example, some embodiments include an image processing apparatus (10, 30), comprising: at least one memory, configured to store computer-readable code; and at least one processor, configured to call the computer-readable code, and perform one or more of the methods described herein.

As another example, some embodiments include a computer-readable medium, wherein computer-readable instructions are stored on the computer-readable medium, and the computer-readable instructions, when executed by a processor, cause the processor to perform one or more of the methods as described herein.

### BRIEF DESCRIPTION OF THE DRAWINGS

FIG. 1 is a structural schematic diagram of an example image processing system incorporating teachings of the present disclosure;

FIG. 2 is a structural schematic diagram of an example video stream processing device incorporating teachings of the present disclosure;

FIG. 3 is a structural schematic diagram of an example picture collecting device incorporating teachings of the present disclosure;

FIG. 4 is a flow chart of an example image processing method at the video stream processing device side incorporating teachings of the present disclosure;

FIG. 5 is a flow chart of an example image processing method at the picture collecting device side incorporating teachings of the present disclosure;

FIG. 6 is a schematic diagram of judging whether a target has entered or abnormally left a region of interest incorporating teachings of the present disclosure; and

FIG. 7 is a schematic diagram of a possible application scenario incorporating teachings of the present disclosure.

### LIST OF LABELS USED IN THE DRAWINGS

| 100: image | 10: video stream | 20: edge computing |
|---|---|---|
| processing system | processing device | device group |
| 201: edge computing device in edge | | 41: video stream |
| computing device group 20 | | before processing |
| 202: edge computing device not in edge | | 42: video stream |
| computing device group 20 | | after processing |
| 30: picture | 400, 500: image | |
| collecting device | processing methods | |
| S401-S406: steps of | S501-S511: steps of | |
| method 400 | method 500 | |
| 111: receiving | 112: segmenting | 113: distributing |
| module | module | module |
| 114: monitoring | 211: receiving | 212: alerting module |
| module | module | |
| 101, 201: at least | 102, 202: at least | 103, 203: |
| one memory | one processor | communication |
| | | module |
| 11, 21: image | 61: region in which | 62: region of |
| processing programs | target is located | interest |
| 60: field of view of | | |
| camera | | |

### DETAILED DESCRIPTION

Embodiments of the present disclosure include image processing methods, apparatus, and computer-readable media, wherein a video stream to be processed is segmented into multiple frames of pictures arranged in chronological order, which are separately distributed to multiple edge computing devices, which do not have high computing power, for image processing such as target identification, in order to achieve an increase in overall computing power and increase the processing speed of target identification. The states of the multiple edge computing devices are identifiable, and it is possible to flexibly add new edge computing devices to, and remove unavailable edge computing devices from, a group formed by the edge computing devices (referred to as an “edge computing device group” hereinbelow), in order to ensure that a video stream will not be unable to be processed normally due to a fault in an individual edge computing device. For a video monitoring application scenario, an optional embodiment of the present invention can monitor whether a person enters or abnormally leaves a region of interest, and make a judgment by comparing trends of change in the relationship between a region in which a target is located and the region of interest, so can effectively avoid misjudgments, increasing the accuracy of judgment. In the process of presenting a monitoring result, an identifier or head portrait of an identified person can be presented in alert information, and a clustering method can be used to find the part best able to display a target feature for presentation, thus increasing the degree of recognition.

In some embodiments, an image processing system comprises:
a video stream processing device, configured to receive a video stream, segment the video stream into multiple frames of pictures arranged in chronological order, and distribute the multiple frames of pictures to edge computing devices in a connected edge computing device group;
the edge computing devices in the edge computing device group, configured to subject the received pictures to target identification, and send, to a connected picture collecting device, the pictures marked with a region in which an identified target is located;
the picture collecting device, configured to restore in chronological order as a video stream the received pictures marked with target identification results.

In some embodiments, an image processing method can be performed by a video stream processing device, the method comprising: receiving a video stream; segmenting the video stream into multiple frames of pictures arranged in chronological order; distributing the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream; monitoring a state of each edge computing device in the edge computing device group and a state of each connected edge computing device outside the edge computing device group; when the state of a first edge computing device in the edge computing device group changes to “unavailable”, removing the first edge computing device from the edge computing device group; when the state of a connected second edge computing device outside the edge computing device group changes to “can be added to the edge computing device group”, adding the second edge computing device to the edge computing device group.

In some embodiments, a video processing method for monitoring a region of interest can be performed by a picture collecting device in the image processing system, and comprises: receiving multiple frames of pictures arranged in chronological order, wherein each frame of picture is marked with a region in which a target identified by target identification is located and the region of interest; judging whether there is an overlap between the region in which the identified target is located and the region of interest marked in each frame of picture received; if there is an overlap, then judging the degree to which the proportion of the area of the region of interest taken up by a region of overlap changes within a preset time period; if the degree of change exceeds a preset change degree threshold, then outputting an alert.

In some embodiments, a video stream processing device comprises:
a receiving module, configured to receive a video stream;
a segmenting module, configured to segment the video stream into multiple frames of pictures arranged in chronological order;
a distributing module, configured to distribute the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream;
a monitoring module, configured to: monitor a state of each edge computing device in the edge computing device group and a state of each connected edge computing device outside the edge computing device group; when the state of a first edge computing device in the edge computing device group changes to “unavailable”, remove the first edge computing device from the edge computing device group; when the state of a connected second edge computing device outside the edge computing device group changes to “can be added to the edge computing device group”, add the second edge computing device to the edge computing device group.

In some embodiments, a picture collecting device for monitoring a region of interest comprises:
a receiving module, configured to receive multiple frames of pictures arranged in chronological order, wherein each frame of picture is marked with a region in which a target identified by target identification is located and the region of interest;
an alerting module, configured to: judge whether there is an overlap between the region in which the identified target is located and the region of interest marked in each frame of picture received; if there is an overlap, then judge the degree to which the proportion of the area of the region of interest taken up by a region of overlap changes within a preset time period; if the degree of change exceeds a preset change degree threshold, then output an alert.

In some embodiments, an image processing apparatus comprises: at least one memory, configured to store computer-readable code; at least one processor, configured to call the computer-readable code, and perform one or more of the methods described herein.

In some embodiments, a computer-readable medium stores computer-readable instructions, and the computer-readable instructions, when executed by a processor, cause the processor to perform one or more of the methods described herein.

In general, a video stream to be processed is segmented into multiple frames of pictures arranged in chronological order, which are separately distributed to multiple edge computing devices, which do not have high computing power, for image processing such as target identification, in order to achieve an increase in overall computing power and increase the processing speed of target identification.

In some embodiments, the video stream processing device may further monitor a state of each edge computing device in the edge computing device group and a state of each connected edge computing device outside the edge computing device group; when the state of a first edge computing device in the edge computing device group changes to “unavailable”, remove the first edge computing device from the edge computing device group; when the state of a connected second edge computing device outside the edge computing device group changes to “can be added to the edge computing device group”, add the second edge computing device to the edge computing device group.

The states of the multiple edge computing devices are identifiable, and it is possible to flexibly add new edge computing devices to, and remove unavailable edge computing devices from, the group formed by the edge computing devices, in order to ensure that a video stream will not be unable to be processed normally due to a fault in an individual edge computing device.

In some embodiments, the systems and/or methods may be used for monitoring a region of interest, wherein the edge computing devices in the edge computing device group mark the region of interest in the received pictures; the picture collecting device judges whether there is an overlap between the region in which the identified target is located and the region of interest marked in each frame of picture received; if there is an overlap, then judges the degree to which the proportion of the area of the region of interest taken up by a region of overlap changes within a preset time period; if the degree of change exceeds a preset change degree threshold, then outputs an alert. For a video monitoring application scenario, it is possible to monitor whether a person enters or abnormally leaves a region of interest, and make a judgment by comparing trends of change in the relationship between a region in which a target is located and the region of interest.

It is thus possible to effectively avoid misjudgments, increasing the accuracy of judgment.

In some embodiments, the picture collecting device compares information of pre-stored targets and the target identified in the received pictures, and judges whether the identified target conforms to information of one pre-stored target; if the identified target conforms to information of one pre-stored target, then marks, in the outputted alert, target information of the pre-stored identified target. If the identified target does not conform to information of any pre-stored target, then it is possible to extract a feature of a key part of the target identified in each frame of picture in the video stream in the preset time period, the key part being used to distinguish between different targets; cluster the frames of pictures according to the extracted feature; acquire a feature located at the cluster center point; obtain the key part of the target in the picture that is most similar to the feature located at the cluster center point; mark the key part so obtained in the outputted alert. For example: in the process of presenting a monitoring result, an identifier or head portrait of an identified person can be presented in alert information, and a clustering method can be used to find the part best able to display a target feature for presentation, thus increasing the degree of recognition.

The subject matter described herein is now discussed with reference to exemplary embodiments. It should be understood that these embodiments are discussed purely in order to enable those skilled in the art to better understand and thus implement the subject matter described herein, without limiting the protection scope, applicability or examples expounded in the claims. The functions and arrangement of the elements discussed can be changed without departing from the protection scope of the content of the disclosure. Various processes or components can be omitted from, replaced in or added to each example as required. For example, the method described may be performed in a different order from that described, and all of the steps may be added, omitted or combined. In addition, features described in relation to some examples may also be combined in other examples.

As used herein, the term “comprises” and variants thereof denote open terms, meaning “including but not limited to”. The term “based on” means “at least partly based on”. The terms “one embodiment” and “an embodiment” mean “at least one embodiment”. The term “another embodiment” means “at least one other embodiment”. The terms “first”, “second”, etc. may denote different or identical objects. Other definitions may be included below, either explicit or implicit. Unless clearly indicated in the context, the definition of a term is the same throughout the specification.

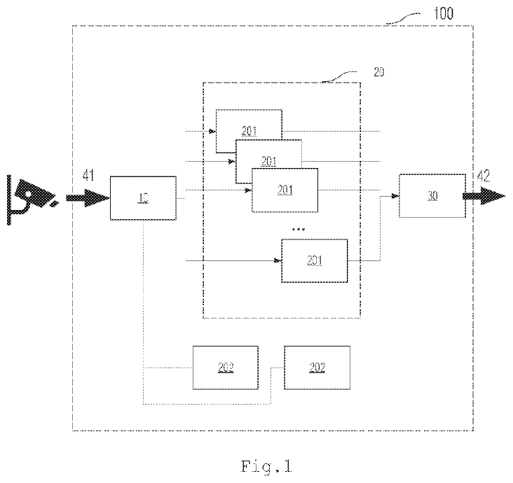

FIG. 1 is a structural schematic diagram of an example image processing system 100 incorporating teachings of the present invention. As shown in FIG. 1, the image processing system 100 may comprise:
a video stream processing device 10, for receiving a video stream 41 acquired by a camera, segmenting the video stream 41 into multiple frames of pictures arranged in chronological order, and distributing the multiple frames of pictures to edge computing devices 201 in a connected edge computing device group 20;
the edge computing device group 20, comprising the edge computing devices 201, which receive the pictures from the video stream processing device 10, subject the pictures to target identification, and send, to a picture collecting device 30, the pictures marked with a region in which an identified target is located (e.g. a partial region enclosed by a bounding box);
the picture collecting device 30, which restores in chronological order as a video stream 42 the pictures marked with the target identification results and received from the edge computing devices 201.

A target identification task is distributed to multiple edge computing devices to be handled separately, instead of being handled on only one device; this parallel processing method considerably speeds up the processing speed of the entire video stream. The performance of a high-performance edge computing device with a GPU can be achieved using multiple low-cost edge computing devices, but the manufacturing cost is lower.

The video stream processing device 10 and the picture collecting device 30 may also be an edge computing device 201 in the edge computing device group 20, performing the function of target identification and also performing picture distribution and image processing.

In some embodiments, in addition to the edge computing devices 201 in the edge computing device group 20, the image processing system 100 may further comprise other edge computing devices 202. The video stream processing device 10 can monitor a state of each edge computing device 201 in the edge computing device group 20 and a state of each connected edge computing device 202 outside the edge computing device group 20. Specifically, when the state of a first edge computing device 201 in the edge computing device group 20 changes to “unavailable”, the first edge computing device 201 is removed from the edge computing device group 20; and when the state of a connected second edge computing device 202 outside the edge computing device group 20 changes to “can be added to the edge computing device group 20”, the second edge computing device 202 is added to the edge computing device group 20.

This form of implementation achieves hot backup. In a conventional method, it is necessary to configure a batch size and a portion of hyper-parameters; moreover, limited by computing power and device internal memory restrictions, the batch size will generally have a small upper limit. This implementation can alter the way in which the edge computing device group is configured and can significantly increase the upper limit of the batch size, thus achieving greater flexibility, and also guaranteeing reliable and timely processing of each picture in the video stream.

The video stream processing device 10 can detect all the available edge computing devices and send pictures to them, and if it is desired to add a new edge computing device to the edge computing device group 20, all that need be done is to connect the video stream processing device 10 to the edge computing device; for example, the new edge computing device can be added to a local area network in which the video stream processing device 10 is located. Furthermore, it is also possible to flexibly alter the configuration of the edge computing device group 20, to conveniently increase or decrease the number of edge computing devices without affecting the image processing task currently being performed. If the state of an edge computing device 201 changes to “unavailable”, for example if the device experiences a fault or a power cut, then the video stream processing device 10 will no longer send pictures to that edge computing device for processing. As another example, a new edge computing device 202 is added to the local area network in which the video stream processing device 10 is located; the video stream processing device 10 can then detect that the state of this new edge computing device 202 has changed to “available”, and adds it to the edge computing device group 20 and sends pictures thereto for processing.

In some embodiments, the video stream processing device 10 can also monitor the state of processing resources of each edge computing device 201 in the edge computing device group 20, distribute more pictures to edge computing devices 201 with ample remaining processing resources for processing, and distribute a small number of pictures to edge computing devices 201 with insufficient remaining processing resources or temporarily not send pictures thereto. This achieves processing load balance among the edge computing devices 201.

One possibility is that an edge computing device 201 does not complete a target identification task in time, so is unable to send a processed picture to the picture collecting device 30 in time; in some embodiments, the picture collecting device 30 acquires the original picture before processing and other frames of pictures and restores these as the video stream 42.

The image processing system 100 may be used in various scenarios to complete image processing tasks, and can effectively increase the processing speed. One possible application scenario is as shown in FIG. 7; the image processing system 100 is used to monitor a region of interest (ROI, region-of-interest) 62. In FIG. 7, 62 is an entrance. A region captured by a camera is 60, and each edge computing device 201 in the edge computing device group 20 marks the ROI 62 in each frame of picture received. In scenarios in which the camera position and capture angle are fixed, it is necessary to record the positional relationship between the ROI 62 and the field of view 60 of the camera when the camera is installed, and notify each edge computing device 201 of the positional relationship; the edge computing devices 201 can then mark the ROI 62 in the pictures according to the positional relationship. When a pedestrian or a vehicle moves into the entrance, the pedestrian or vehicle will appear in the field of view of the camera. The edge computing devices 201 identify the pedestrian and vehicle by target identification, and use bounding boxes to mark a region 61 in which the pedestrian or vehicle is located in the pictures.

Thus, both the region 61 in which the identified target is located and the ROI 62 are marked in the pictures collected by the picture collecting device 30. In some embodiments, in order to judge whether a target has entered or abnormally left the monitored ROI 62, for each frame of picture, the picture collecting device 30 can judge whether there is an overlap between the ROI 62 and the region 61 in which the identified target is located; if there is an overlap, then the degree to which the proportion of the area of the ROI taken up by a region of overlap changes within a preset time period (e.g. 10 s) is judged. If the degree of change exceeds a preset change degree threshold, then an alert is outputted. The degree of change within a preset time period is used for judgment in order to avoid misjudgments caused by errors in the results of target identification in individual frames.

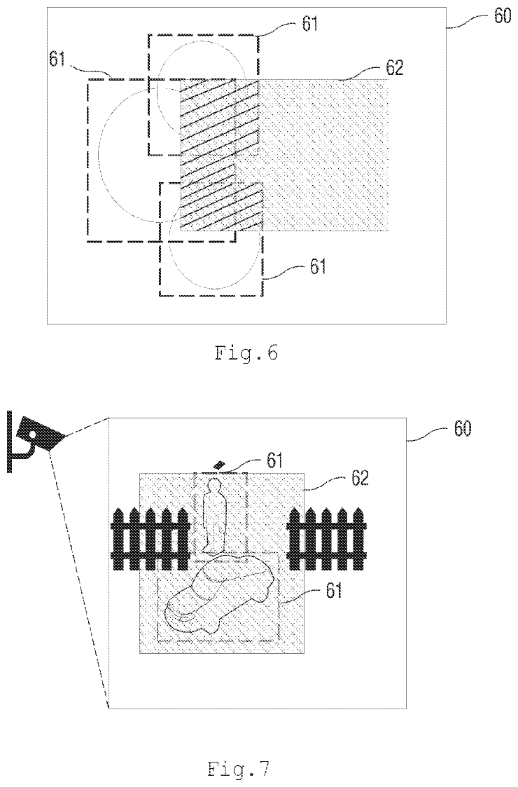

The above-described judgment process of the picture collecting device 30 is explained below with reference to FIG. 6. As can be seen from FIG. 6, three targets have been identified in the current frame of picture; the regions in which these are located are all marked 61, while the ROI is 62. In the figure, the shaded parts marked with oblique lines are regions of overlap between the ROI 62 and the regions 61 in which the identified targets are located.

If the proportion of the area of the ROI 62 taken up by the region of overlap exceeds a preset threshold within a preset time period, then it is concluded that a target has entered the ROI 62 (if the proportion taken up increases by an amount exceeding the preset threshold), or that a target has abnormally left the ROI 62 (if the proportion taken up decreases by an amount exceeding the preset threshold). Of course, the two thresholds used to judge that a target has entered and that a target has abnormally left may be different. Misjudgments can also be avoided by setting the preset threshold.

The picture collecting device 30 can judge whether a target has entered or abnormally left the ROI 62 based on the received pictures; furthermore, the picture collecting device 30 can mark target-related information in the outputted alert in the following optional fashion.

The picture collecting device 30 can compare information of pre-stored targets and the targets identified in the received pictures, and judge whether an identified target conforms to information of one pre-stored target; if the identified target conforms to information of one pre-stored target, then target information of the pre-stored identified target is marked in the outputted alert, e.g. an identifier ID of the target. If the target is a person, then information such as the person's name and job title can be marked; if the target is a vehicle, then information such as the vehicle's license plate number can be marked. If the identified targets do not conform to information of any pre-stored target, the picture collecting device 30 can extract features of key parts of the targets identified in each frame of picture in the video stream in a preset time period, the key parts being used to distinguish between different targets. The frames of pictures are clustered according to the extracted features, a feature located at the cluster center point is acquired, the key part of the target in the picture that is most similar to the feature located at the cluster center point is obtained, and the key part so obtained is marked in the outputted alert. For example: if the target is a person, then the person's face can be marked; if the target is a vehicle, then the vehicle's license plate region can be marked, and so on. The most identifiable key parts can be found through this clustering method.

The solution shown in FIG. 1 can be deployed quickly and easily, to achieve the same processing speed and accuracy as a high-performance GPU, and the cost will be greatly reduced. In addition, using the optional implementation method of hot backup mentioned above, edge computing devices can be added easily without the need for additional configuration, to expand the edge computing device group.

The solution shown in FIG. 1 can be used for monitoring of regions of interest, for example: registration and identification of visitors in a building, monitoring of region entrances, and so on. The edge computing devices are generally small in volume, and relatively easy to deploy at front desks, main doors, etc. With the solution provided in embodiments of the present invention, the computing power provided by the edge computing device group is sufficient to perform corresponding image processing, being capable of rapid target identification, e.g. face recognition, etc.

The video stream processing device 10 and picture collecting device 30 provided in embodiments of the present invention are presented below; both of these devices can be regarded as image processing apparatuses.

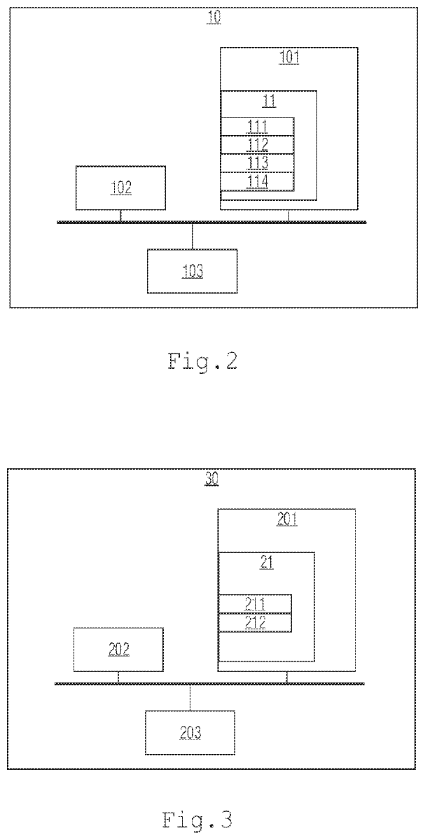

The video stream processing device 10 may be implemented as a network of computer processors, in order to perform one or more of the image processing methods described herein. The video stream processing device 10 may also be a single computer as shown in FIG. 2, comprising at least one memory 101, which comprises a computer readable medium, e.g. random access memory (RAM). The apparatus 11 further comprises at least one processor 102 coupled to the at least one memory 101. Computer executable instructions are stored in the at least one memory 101, and, when executed by the at least one processor 102, can cause the at least one processor 102 to perform the methods described herein.

The at least one processor 102 may comprise a microprocessor, an application specific integrated circuit (ASIC), a digital signal processor (DSP), a central processing unit (CPU), a graphics processing unit (GPU), a state machine, etc. Embodiments of computer readable media include, but are not limited to, floppy disks, CD-ROM, magnetic disks, memory chips, ROM, RAM, ASIC, configured processors, all-optical media, all magnetic tapes or other magnetic media, or any other media from which instructions can be read by a computer processor. In addition, various other forms of computer readable media may send or carry instructions to a computer, including routers, dedicated or public networks, or other wired and wireless transmission devices or channels. The instructions may include code of any computer programming language, including C, C++, C language, Visual Basic, Java and JavaScript.

When executed by the at least one processor 102, the at least one memory 101 shown in FIG. 2 may contain an image processing program 11, which causes the at least one processor 102 to perform one or more of the image processing methods described herein.

The image processing program 11 may comprise:
a receiving module 111, configured to receive a video stream;
a segmenting module 112, configured to segment the video stream into multiple frames of pictures arranged in chronological order;
a distributing module 113, configured to distribute the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream;
a monitoring module 114, configured to: monitor a state of each edge computing device in the edge computing device group and a state of each connected edge computing device outside the edge computing device group; when a first edge computing device in the edge computing device group experiences a fault, remove the first edge computing device from the edge computing device group; and when the state of a connected second edge computing device outside the edge computing device group changes to “can be added to the edge computing device group”, add the second edge computing device to the edge computing device group.

In some embodiments, the video stream processing device 10 may further comprise a communication module 103, connected to the at least one processor 102 and the at least one memory 101 via a bus, and used for communication between the video stream processing device 10 and an external device.

The modules described above may also be regarded as functional modules realized by hardware, for performing the various functions which are involved when the video stream processing device 10 performs the image processing method. For example, control logic of the processes involved in the method is burned into field-programmable gate array (FPGA) chips or complex programmable logic devices (CPLD) etc. in advance, with these chips or devices executing the functions of the modules described above. The particular manner of implementation may be determined according to engineering practice.

In some embodiments, the picture collecting device 30 may be implemented as a network of computer processors, in order to perform one or more of the image processing methods described herein. The picture collecting device 30 may also be a single computer as shown in FIG. 3, comprising at least one memory 201, which comprises a computer readable medium, e.g. random access memory (RAM). The apparatus 12 further comprises at least one processor 202 coupled to the at least one memory 201. Computer executable instructions are stored in the at least one memory 201, and, when executed by the at least one processor 202, can cause the at least one processor 202 to perform one or more of the methods described herein.

The at least one processor 202 may comprise a microprocessor, an application specific integrated circuit (ASIC), a digital signal processor (DSP), a central processing unit (CPU), a graphics processing unit (GPU), a state machine, etc. Embodiments of computer readable media include, but are not limited to, floppy disks, CD-ROM, magnetic disks, memory chips, ROM, RAM, ASIC, configured processors, all-optical media, all magnetic tapes or other magnetic media, or any other media from which instructions can be read by a computer processor. In addition, various other forms of computer readable media may send or carry instructions to a computer, including routers, dedicated or public networks, or other wired and wireless transmission devices or channels. The instructions may include code of any computer programming language, including C, C++, C language, Visual Basic, Java and JavaScript.

When executed by the at least one processor 202, the at least one memory 201 shown in FIG. 3 may contain an image processing program 21, which causes the at least one processor 202 to perform one or more of the image processing methods described herein. The image processing program 21 may comprise:
a receiving module 211, configured to receive multiple frames of pictures arranged in chronological order, wherein each frame of picture is marked with a region in which a target identified by target identification is located and a region of interest;
an alerting module 212, configured to: judge whether there is an overlap between the region in which the identified target is located and the region of interest marked in each frame of picture received; if there is an overlap, then judge the degree to which the proportion of the area of the region of interest taken up by a region of overlap changes within a preset time period; and if the degree of change exceeds a preset change degree threshold, then output an alert.

In some embodiments, the alerting module 212 is further configured to: compare information of pre-stored targets and the target identified in the pictures received by the receiving module 211, and judge whether the identified target conforms to information of one pre-stored target; and if the identified target conforms to information of one pre-stored target, then mark, in the outputted alert, target information of the pre-stored identified target.

In some embodiments, the alerting module 212 may also be configured to: if the identified target does not conform to information of any pre-stored target, then extract a feature of a key part of the target identified in each frame of picture in the video stream in a preset time period, the key part being used to distinguish between different targets; cluster the frames of pictures according to the extracted feature; acquire a feature located at the cluster center point; obtain the key part of the target in the picture that is most similar to the feature located at the cluster center point; and mark the key part so obtained in the outputted alert.

In some embodiments, the picture collecting device 30 may further comprise a communication module 203, connected to the at least one processor 202 and the at least one memory 201 via a bus, and used for communication between the picture collecting device 30 and an external device.

The modules described above may also be regarded as functional modules realized by hardware, for performing the various functions which are involved when the picture collecting device 30 performs the image processing method. For example, control logic of the processes involved in the method is burned into field-programmable gate array (FPGA) chips or complex programmable logic devices (CPLD) etc. in advance, with these chips or devices executing the functions of the modules described above. The particular manner of implementation may be determined according to engineering practice.

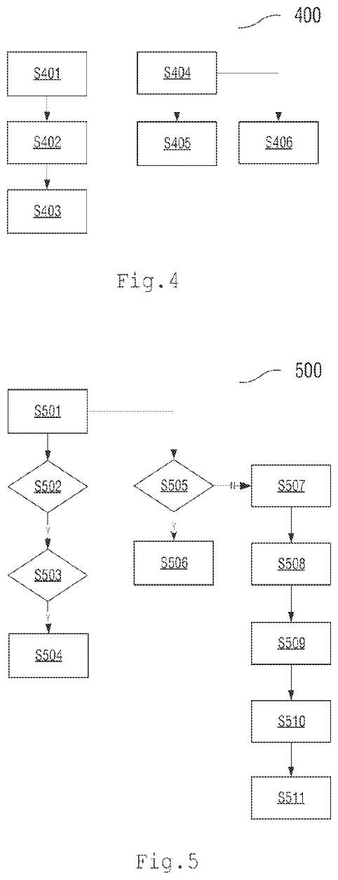

The image processing method 400 is explained below with reference to FIG. 4. As shown in FIG. 4, the method may comprise the following steps:
S401: receiving a video stream;
S402: segmenting the video stream into multiple frames of pictures arranged in chronological order;
S403: distributing the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream;
S404: monitoring a state of each edge computing device in the edge computing device group and a state of each connected edge computing device outside the edge computing device group;
S405: when a first edge computing device in the edge computing device group experiences a fault, removing the first edge computing device from the edge computing device group; and
S406: when the state of a connected second edge computing device outside the edge computing device group changes to “can be added to the edge computing device group”, adding the second edge computing device to the edge computing device group.

The example image processing method 500 explained below with reference to FIG. 5. As FIG. 5 shows, the method may comprise:
S501: receiving multiple frames of pictures arranged in chronological order, wherein each frame of picture is marked with a region in which a target identified by target identification is located and a region of interest;
S502: judging whether there is an overlap between the region in which the identified target is located and the region of interest marked in each frame of picture received; if there is an overlap, then performing step S503;
S503: judging the degree to which the proportion of the area of the region of interest taken up by a region of overlap changes within a preset time period; and if the degree of change exceeds a preset change degree threshold, then performing step S504; and
S504: outputting an alert.

In some embodiments, the method 500 may further comprise one or more of the following:
S505: comparing information of pre-stored targets and the target identified in the received pictures, and judging whether the identified target conforms to information of one pre-stored target; if the identified target conforms to information of one pre-stored target, then performing step S506; if the identified target does not conform to information of any pre-stored target, then performing step S507-S511;
S506: marking, in the outputted alert, target information of the pre-stored identified target.
S507: extracting a feature of a key part of the target identified in each frame of picture in the video stream in a preset time period, the key part being used to distinguish between different targets;
S508: clustering the frames of pictures according to the extracted feature;
S509: acquiring a feature located at the cluster center point;
S510: obtaining the key part of the target in the picture that is most similar to the feature located at the cluster center point;
S511: marking the key part so obtained in the outputted alert.

In some embodiments, a computer-readable medium stores a computer-readable instruction, and the computer-readable instruction, when executed by a processor, causes the processor to perform one or more of the image processing methods described above. Examples of computer-readable media include floppy disks, hard disks, magneto-optical disks, optical disks (such as CD-ROM, CD-R, CD-RW, DVD-ROM, DVD-RAM, DVD-RW, DVD+RW), magnetic tapes, non-volatile memory cards and ROM. Optionally, a computer-readable instruction may be downloaded from a server computer or a cloud via a communication network.

It must be explained that not all of the steps and modules in the flows and system structure diagrams above are necessary; certain steps or modules may be omitted according to actual requirements.

The order in which steps are executed is not fixed, but may be adjusted as required. The system structures described in the embodiments above may be physical structures, and may also be logical structures, i.e. some modules might be realized by the same physical entity, or some modules might be realized by multiple physical entities, or realized jointly by certain components in multiple independent devices.

What is claimed is:

1. An image processing system comprising:
a video stream processing device configured to receive a video stream, segment the video stream into multiple frames of pictures arranged in chronological order, and distribute the multiple frames of pictures to edge computing devices in a connected edge computing device group; and
a picture collecting device configured to receive pictures from the edge computing device group;
the edge computing devices in the edge computing device group are each configured to subject the received pictures to target identification, and send the pictures marked with a region in which an identified target is located;
wherein the picture collecting device is further configured to restore in chronological order as a video stream the received pictures marked with target identification results.

2. The system as claimed in claim 1, wherein the video stream processing device is further configured to:
monitor a state of each edge computing device in the edge computing device group and a state of each connected edge computing device outside the edge computing device group;
when the state of a first edge computing device in the edge computing device group changes to “unavailable”, remove the first edge computing device from the edge computing device group;
when the state of a connected second edge computing device outside the edge computing device group changes to “can be added to the edge computing device group”, add the second edge computing device to the edge computing device group.

3. The system as claimed in claim 1, wherein:
the system is used for monitoring a region of interest,
the edge computing devices in the edge computing device group is further configured to
mark the region of interest in the received pictures; and
the picture collecting device is further configured to:
judge whether there is an overlap between the region in which the identified target is located and the region of interest marked in each frame of picture received;
if there is an overlap, then judge the degree to which the proportion of the area of the region of interest taken up by a region of overlap changes within a preset time period;
if the degree of change exceeds a preset change degree threshold, then output an alert.

4. The system as claimed in claim 1, wherein the picture collecting device is further configured to:
compare information of pre-stored targets and the target identified in the received pictures, and judge whether the identified target conforms to information of one pre-stored target; and
if the identified target conforms to information of one pre-stored target, then mark, in the outputted alert, target information of the pre-stored identified target.

5. The system as claimed in claim 4, wherein the picture collecting device is further configured to; if the identified target does not conform to information of any pre-stored target, then:
extract a feature of a key part of the target identified in each frame of picture in the video stream in the preset time period, the key part being used to distinguish between different targets;
cluster the frames of pictures according to the extracted feature;
acquire a feature located at the cluster center point;
obtain the key part of the target in the picture that is most similar to the feature located at the cluster center point; and
mark the key part so obtained in the outputted alert.

6. An image processing method comprising:
receiving a video stream;
segmenting the video stream into multiple frames of pictures arranged in chronological order;
distributing the multiple frames of pictures to edge computing devices in a connected edge computing device group, to enable the edge computing devices in the edge computing device group to subject the received pictures to target identification, wherein the pictures marked with a region in which an identified target is located are restored in chronological order as a video stream;
monitoring a state of each edge computing device in the edge computing device group and a state of each connected edge computing device outside the edge computing device group;
when the state of a first edge computing device in the edge computing device group changes to “unavailable”, removing the first edge computing device from the edge computing device group; and
when the state of a connected second edge computing device outside the edge computing device group changes to “can be added to the edge computing device group”, adding the second edge computing device to the edge computing device group.

7. An image processing method for monitoring a region of interest, the method comprising:
receiving multiple frames of pictures arranged in chronological order, wherein each frame of picture is marked with a region in which a target identified by target identification is located and the region of interest;
judging whether there is an overlap between the region in which the identified target is located and the region of interest marked in each frame of picture received;
if there is an overlap, then judging the degree to which the proportion of the area of the region of interest taken up by a region of overlap changes within a preset time period;
if the degree of change exceeds a preset change degree threshold, then outputting an alert.

8. The method as claimed in claim 7, further comprising:
comparing information of pre-stored targets and the target identified in the received pictures, and judging whether the identified target conforms to information of one pre-stored target; and
if the identified target conforms to information of one pre-stored target, then marking, in the outputted alert, target information of the pre-stored identified target.

9. The method as claimed in claim 8, further comprising, if the identified target does not conform to information of any pre-stored target, then:
extracting a feature of a key part of the target identified in each frame of picture in the video stream in the preset time period, the key part being used to distinguish between different targets;
clustering the frames of pictures according to the extracted feature;
acquiring a feature located at the cluster center point;
obtaining the key part of the target in the picture that is most similar to the feature located at the cluster center point; and
marking the key part so obtained in the outputted alert.

10. (canceled)

11. A picture collecting device for monitoring a region of interest, the device comprising:
a receiving module configured to receive multiple frames of pictures arranged in chronological order, wherein each frame of picture is marked with a region in which a target identified by target identification is located and the region of interest;
an alerting module configured to:
judge whether there is an overlap between the region in which the identified target is located and the region of interest marked in each frame of picture received;
if there is an overlap, then judge the degree to which the proportion of the area of the region of interest taken up by a region of overlap changes within a preset time period; and
if the degree of change exceeds a preset change degree threshold, then output an alert.

12. The device as claimed in claim 11, wherein the alerting module is further configured to:
compare information of pre-stored targets and the target identified in the pictures received by the receiving module (211), and judge whether the identified target conforms to information of one pre-stored target;
if the identified target conforms to information of one pre-stored target, then mark, in the outputted alert, target information of the pre-stored identified target.

13. The device as claimed in claim 12, wherein the alerting module is further configured to, if the identified target does not conform to information of any pre-stored target, then:
extract a feature of a key part of the target identified in each frame of picture in the video stream in the preset time period, the key part being used to distinguish between different targets;
cluster the frames of pictures according to the extracted feature;
acquire a feature located at the cluster center point;
obtain the key part of the target in the picture that is most similar to the feature located at the cluster center point; and
mark the key part so obtained in the outputted alert.

14-15. (canceled)
